(19) United States
(12) Patent Application Publication
(10) Pub. No.: US 2024/0139660 A1
(43) Pub. Date: May 2, 2024

(54) FRACTURE SHIELD FILTER TOOL, METHOD AND SYSTEM

(71) Applicant: Baker Hughes Oilfield Operations LLC, Houston, TX (US)

(72) Inventor: Matthew Stone, Humble, TX (US)

(21) Appl. No.: 17/975,194

(22) Filed: Oct. 27, 2022

(51) Int. Cl. B01D 35/31; B01D 35/02

(52) U.S. Cl. CPC B01D 35/31; B01D 35/02

(57) ABSTRACT

A fracture shielded filter tool including a mandrel, a filtration material disposed in a position relative to the mandrel to filter a fluid moving between an exterior of the mandrel and an interior of the mandrel, and a shield adjacent the filtration material and positioned to protect the filtration material from fluid associated with a fracture operation. A method for fracturing including running the tool to a target location, initiate a fracturing operation, shielding the filtration material from fluid associated with the fracturing operation and removing the shield thereby allowing fluid flow through the filtration material. A borehole system including a borehole in a subsurface formation, a string in the borehole and a tool disposed as part of or within the string.

### BACKGROUND

In the resource recovery and fluid sequestration industries there is often a need for filtration. Filter materials are quite effective but are also easily damaged by high flow rates. An example is during a fracturing operation. Hence, the art has avoided using some of the more susceptible filtration materials even though they might also be better suited to the filtration task simply because they are unlikely to survive operations to which they would be subjected that encompass high flow rates. The art would welcome innovations that allow the use of such filtration materials.

### SUMMARY

An embodiment of a fracture shielded filter tool including a mandrel, a filtration material disposed in a position relative to the mandrel to filter a fluid moving between an exterior of the mandrel and an interior of the mandrel, and a shield adjacent the filtration material and positioned to protect the filtration material from fluid associated with a fracture operation.

An embodiment of a method for fracturing including running the tool to a target location, initiate a fracturing operation, shielding the filtration material from fluid associated with the fracturing operation and removing the shield thereby allowing fluid flow through the filtration material.

An embodiment of a borehole system including a borehole in a subsurface formation, a string in the borehole and a tool disposed as part of or within the string.

### BRIEF DESCRIPTION OF THE DRAWINGS

The following descriptions should not be considered limiting in any way. With reference to the accompanying drawings, like elements are numbered alike:

FIG. 1 is a sectional view of a fracture shielded filter tool as disclosed herein in an initial position;

FIG. 2 is the tool of FIG. 1 with a fracture object landed;

FIG. 3 is the tool of FIG. 1 with fracture ports open;

FIG. 4 is the tool of FIG. 1 with fracture fluid flowing;

FIG. 5 is the tool of FIG. 1 with a production object landed;

FIG. 6 is the tool of FIG. 1 with the fracture ports closed and production ports open;

FIG. 7 is the tool of FIG. 1 with a shield degrading fluid applied to the shield;

FIG. 8 is the tool of FIG. 1 with an activation fluid applied to the filtration material and illustrating the filtration material expanded;

FIG. 9 is an alternate embodiment of a fracture shielded filter tool; and

FIG. 10 is a view of a borehole system including a fracture shielded filter tool as disclosed herein.

### DETAILED DESCRIPTION

A detailed description of one or more embodiments of the disclosed apparatus and method are presented herein by way of exemplification and not limitation with reference to the Figures.

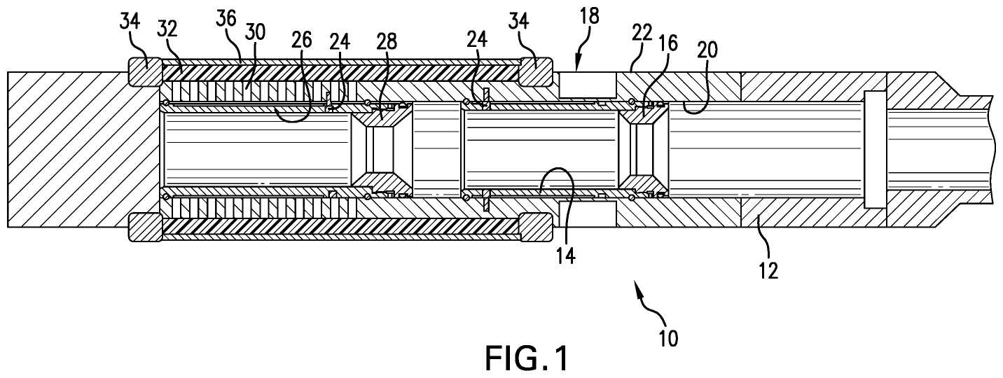

Referring to FIG. 1, a fracture shielded filter tool 10 is illustrated. Tool 10 has a dual function related to fracturing a formation and producing fluids from the formation through a filter material. The tool 10 includes a sleeve housing or mandrel 12 wherein a fracture sleeve 14 having a fracture seat 16 is slidably located. The fracture sleeve 14 initially is positioned in the housing 12 to cover a fracture port 18 extending from an inside diameter 20 to an outside diameter 22 of the housing 12. In an embodiment, the fracture sleeve 14 is retained in the initial position wherein the fracture port 18 is covered by fracture sleeve 14 and is thereby closed. The retention is supported by a release member 24, such as a shear screw or other release configuration. Also in the housing 12 is a production sleeve 26 having a production seat 28 therein. Production sleeve 26 initially is positioned to cover a production port 30. Production sleeve 26 may also be retained in the initial position via a release member 24. Radially outwardly of the port 30 is a filtration material 32. In embodiments, the filtration material 32 may be bounded longitudinally by end rings 34. The filtration material 32 may be of wire type, bead type, etc. or may be of an expanding type such as a shape memory polymer (for example GeoFORM™ material commercially available from Baker Hughes), swellable material, etc. In some cases, the filtration material is configured to conform to the inside dimensions of a borehole.

The tool 10 is also configured with a shield to protect the filtration material from fracture fluid during a fracturing operation. In one embodiment a shield 36 is disposed about the filtration material 32. The shield may be deposited on the filtration material or overlayed thereon. As illustrated in FIG. 1, the shield 36 extends longitudinally from end ring 34 to end ring 34. The filtration material in some embodiments may be surrounded by the shield 36, end rings 34, and the housing 12. In embodiments the shield may be a degradable, dissolvable, corrodible, disintegrable or otherwise configured to go away based upon an application of a fluid or based upon a short and intended time at temperature or in aqueous or hydrocarbon fluid. The use of the terms related to degradation herein are not intended to encompass a normal process over extended periods of time such as the rusting of a material over decades but rather are intended to convey that a particular degradable material will degrade in a short time of hours to days upon exposure to conditions under which the material is designed to degrade. One example of such material is Corrodible Metallic Material (CEM™) commercially available from Baker Hughes, or other magnesium-based material configured for degradation in the time frames noted. Another example is a degrade on demand material also commercially available from Baker Hughes. Additional similar materials are contemplated. In other embodiments, the shield is a relatively low tensile strength material (for example magnesium, aluminum, or even a glass strengthened cynate ester) that will rupture under the stress caused by an expanding filtration material 32. Yet further, the shield 36 may be constructed of a material having one or more lines of weakness therein that will encourage rupture under the stress of the expanding filtration material 32. Lines of weakness may be areas of the shield where the radial thickness thereof has been reduced or different materials are used or different properties of the same material are used. Additive manufacturing may be useful in producing shields of this nature. In any event, each of the lines of weakness embodiments will rupture more easily along the lines of weakness, those lines essentially creating a stress riser for the shield and leading to its destruction.

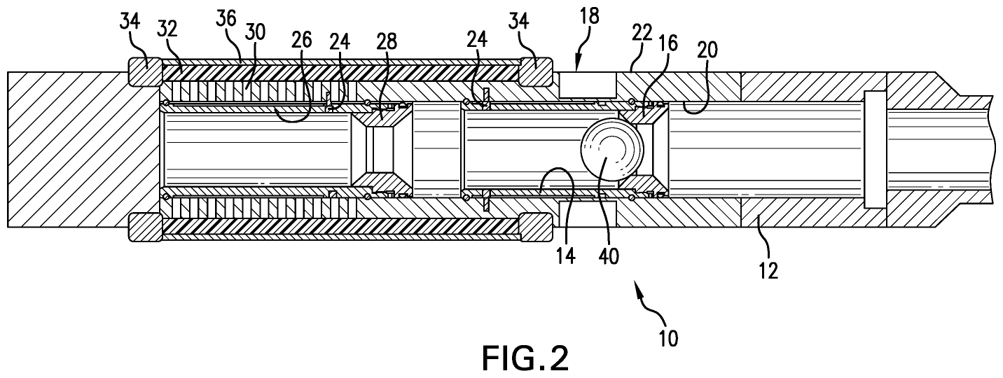

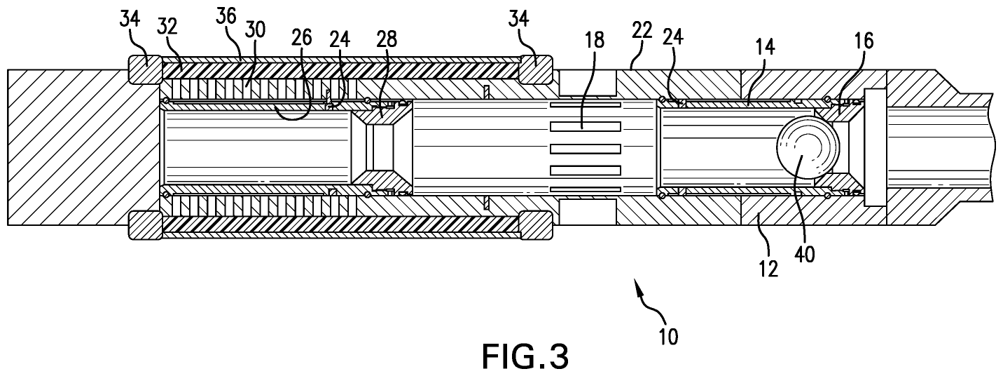

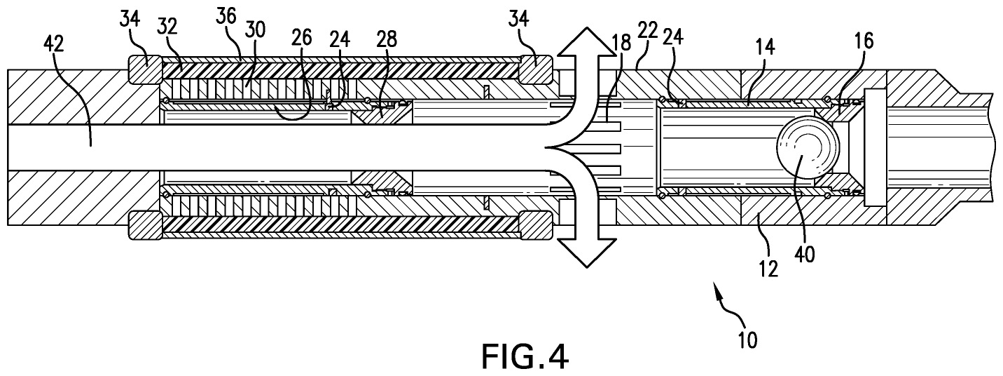

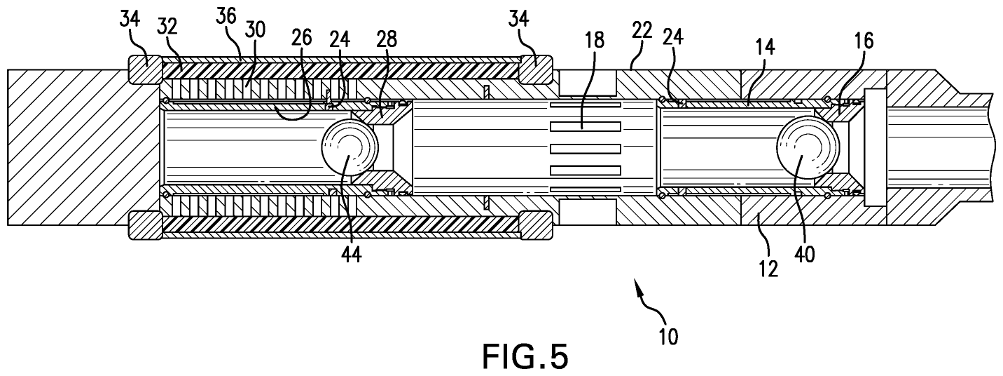

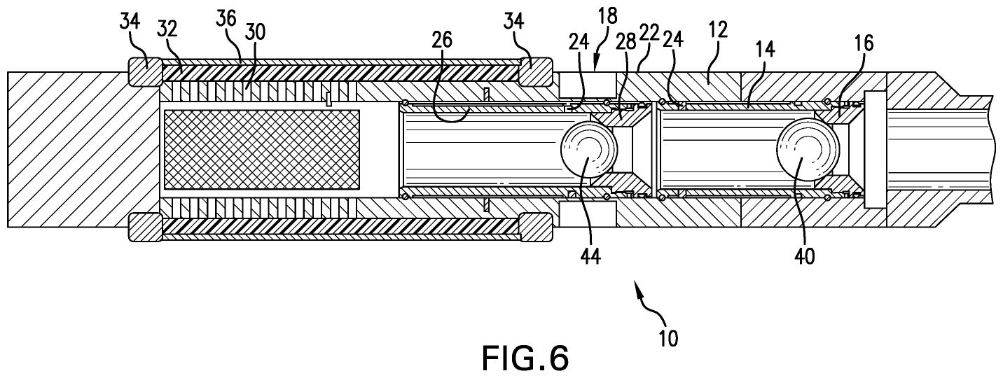

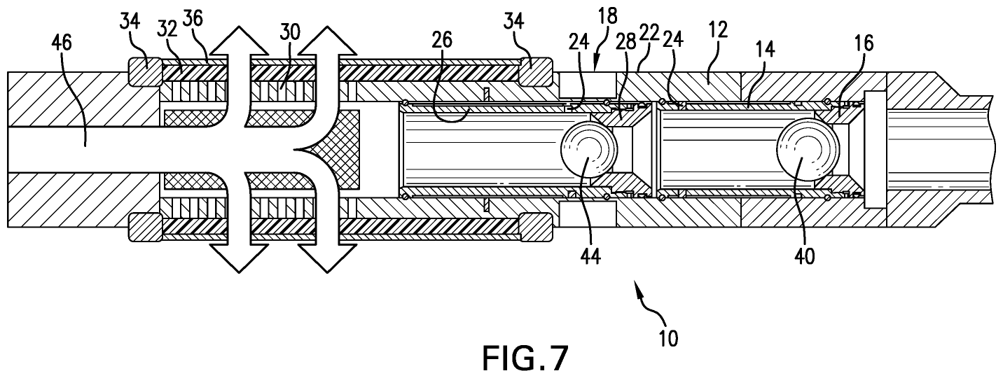

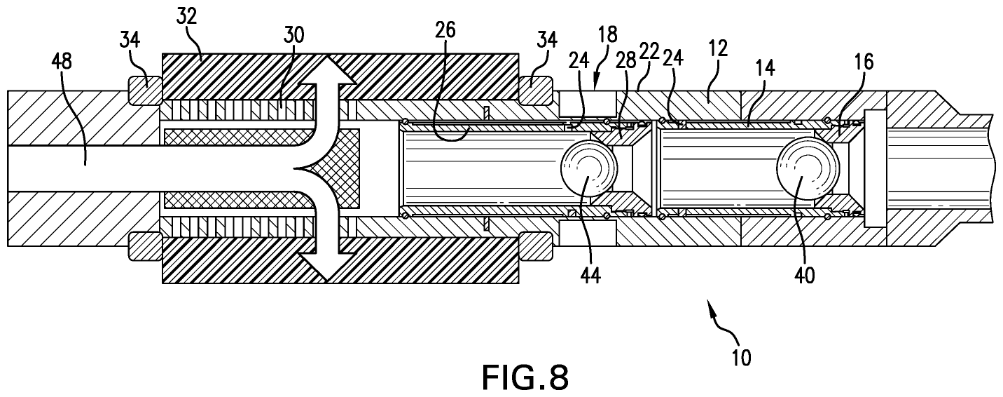

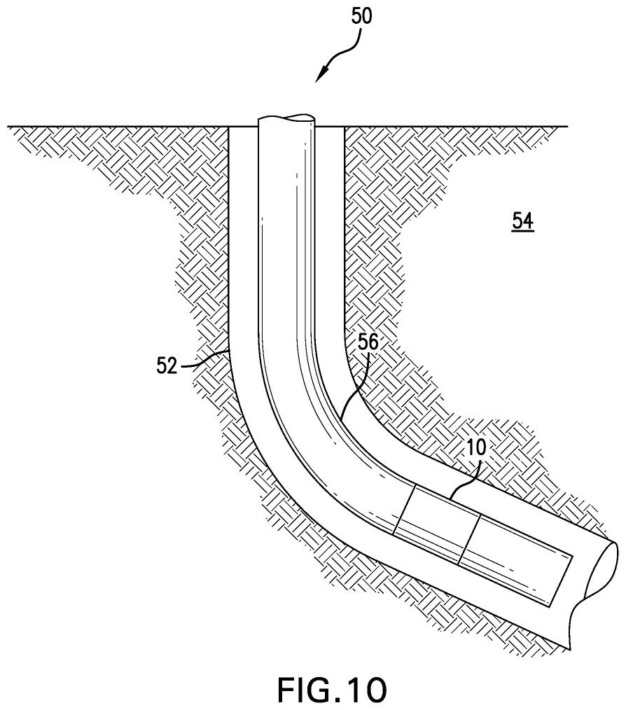

In use, the tool 10 is run into a borehole (See FIG. 10) to a target position. Next, (see FIG. 2) a fracture object 40 is conveyed to the fracture seat 16 and landed there. Pressure against the object 40 releases the release member 24 (see FIG. 3) and causes the fracture sleeve 14 to slide in housing 12, thereby uncovering fracture port 18. Next, a fracture fluid 42 (see FIG. 4) is pumped out through port 18 to fracture the formation existing outside of the housing 12. It will be appreciated that while this fracture fluid 42 is being pumped into the formation, the shield 36 remains intact protecting the filtration material 32 from the ravages of generally fast moving and high pressure fracture fluid. Once the fracture operation has been completed, a production object 44 (see FIG. 5) may be conveyed to the production seat 28 and landed thereon. Pressure against the production object 44 and the production seat 28 will cause the production sleeve 26 to move (see FIG. 6) thereby exposing the production port 30 to the inside diameter 20 of the housing 12 and also covering the fracture port 18. It will be appreciated that the release member 24 has released between FIGS. 5 and 6 due to the pressure applied against production object 44 and production seat 28. With the production port 30 open, a degradation fluid 46 may be applied to the shield 36 (see FIG. 7) in an embodiment. Where such a fluid is to be used, the fluid would be harmless to the filtration material tuype selected during manufacture. For example, if a CEM shield 36 is employed over a polymeric shape memory material such as GeoForm™ material, a fluid such as sodium bromide, acetic acid or hydrochloric acid may be used to degrade the shield 36 while preserving the filtration material 32. Subsequent to shield degradation chemically or with another embodiment of shield still intact, such as the lower tensile strength shield or the shield with lines of weakness discussed above, an actuation fluid 48 may be applied (see FIG. 8) to expand the filtration material 32. Activation fluids that might be used include acetyl acetone for shape memory polymers, water based fluids or oil based fluids for swellable materials, etc. With the shield 36 degraded, gone or otherwise breached and the filtration material exposed for fluid flow therethrough (whether in expanded state or as a static filter material) the tool 10 is ready for production from the formation or filtered injection into the formation.

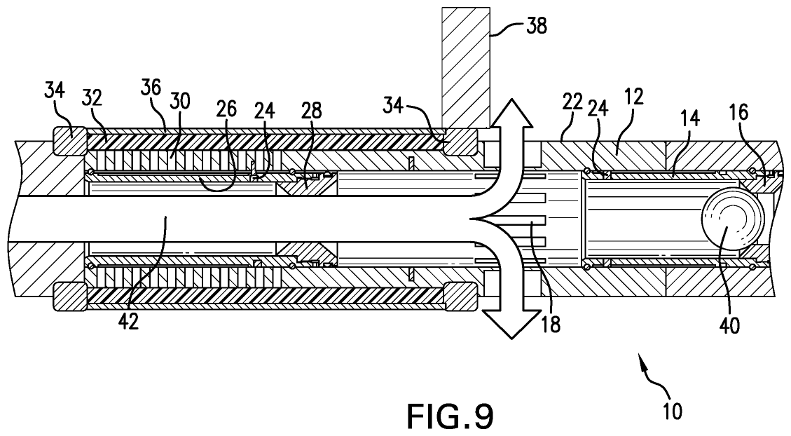

Referring to FIG. 9, an alternate embodiment of the fracture shielded filter tool 10 is illustrated where an expandable member shield 38 is illustrated that will protect the filtration material 32 from fracture fluid. The shield 38 is positioned between the filtration material 32 and the fracture port 18 such that fracture fluid does not reach the filtration material 32 during the fracture operation. Such a shield 38 may comprise a swellable material or shape memory material such as a shape memory alloy, for example. In this embodiment, the shield 36 would not be required (although it is still included in the drawing as a possible additional protection). This embodiment may reduce the range of fracture formation radially outwardly of the filtration material 32.

Referring to FIG. 10, a borehole system is illustrated. The system 50 comprises a borehole 52 in a subsurface formation 54. A string 56 is disposed within the borehole 52. A fracture shielded filter tool 10 is disposed within or as a part of the string 56.

Set forth below are some embodiments of the foregoing disclosure:

Embodiment 1: A fracture shielded filter tool including a mandrel, a filtration material disposed in a position relative to the mandrel to filter a fluid moving between an exterior of the mandrel and an interior of the mandrel, and a shield adjacent the filtration material and positioned to protect the filtration material from fluid associated with a fracture operation.

Embodiment 2: The tool as in any prior embodiment, wherein the shield is a degradable material.

Embodiment 3: The tool as in any prior embodiment, wherein the degradable material is a controlled electrolytic metallic material.

Embodiment 4: The tool as in any prior embodiment, wherein the shield is a reduced tensile strength material.

Embodiment 5: The tool as in any prior embodiment, wherein the shield is a weakened material.

Embodiment 6: The tool as in any prior embodiment, wherein the shield is weakened by including reduced thickness portions.

Embodiment 7: The tool as in any prior embodiment, wherein the portions are lines.

Embodiment 8: The tool as in any prior embodiment, wherein the shield is positioned between a fracture port of the tool and the filtration material.

Embodiment 9: The tool as in any prior embodiment, wherein the shield covers the filtration material.

Embodiment 10: The tool as in any prior embodiment, wherein the shield and mandrel together surround the filtration material.

Embodiment 11: The tool as in any prior embodiment, wherein the filtration material is an expandable material.

Embodiment 12: The tool as in any prior embodiment, wherein the expandable material is a shape memory material.

Embodiment 13: The tool as in any prior embodiment, wherein the shape memory material is a shape memory polymer.

Embodiment 14: The tool as in any prior embodiment, wherein the expandable material is a swellable material.

Embodiment 15: A method for fracturing including running the tool as in any prior embodiment to a target location, initiate a fracturing operation, shielding the filtration material from fluid associated with the fracturing operation and removing the shield thereby allowing fluid flow through the filtration material.

Embodiment 16: The method as in any prior embodiment, wherein the removing is degrading.

Embodiment 17: The method as in any prior embodiment, wherein the removing is rupturing.

Embodiment 18: The method as in any prior embodiment, further including expanding the filtration material.

Embodiment 19: The method as in any prior embodiment, further including applying an actuator fluid to the filtration material to trigger the filtration material to expand.

Embodiment 20: A borehole system including a borehole in a subsurface formation, a string in the borehole and a tool as in any prior embodiment disposed as part of or within the string.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” includes a range of ±8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A fracture shielded filter tool, comprising:
a mandrel;
a filtration material disposed in a position relative to the mandrel to filter a fluid moving between an exterior of the mandrel and an interior of the mandrel; and
a shield adjacent the filtration material and positioned to protect the filtration material from fluid associated with a fracture operation.

2. The tool as claimed in claim 1, wherein the shield is a degradable material.

3. The tool as claimed in claim 2, wherein the degradable material is a controlled electrolytic metallic material.

4. The tool as claimed in claim 1, wherein the shield is a reduced tensile strength material.

5. The tool as claimed in claim 1, wherein the shield is a weakened material.

6. The tool as claimed in claim 1, wherein the shield is weakened by including reduced thickness portions.

7. The tool as claimed in claim 6, wherein the portions are lines.

8. The tool as claimed in claim 1, wherein the shield is positioned between a fracture port of the tool and the filtration material.

9. The tool as claimed in claim 1, wherein the shield covers the filtration material.

10. The tool as claimed in claim 1, wherein the shield and mandrel together surround the filtration material.

11. The tool as claimed in claim 1, wherein the filtration material is an expandable material.

12. The tool as claimed in claim 8, wherein the expandable material is a shape memory material.

13. The tool as claimed in claim 12, wherein the shape memory material is a shape memory polymer.

14. The tool as claimed in claim 8, wherein the expandable material is a swellable material.

15. A method for fracturing comprising:
running the tool as claimed in claim 1 to a target location;
initiate a fracturing operation;
shielding the filtration material from fluid associated with the fracturing operation; and
removing the shield thereby allowing fluid flow through the filtration material.

16. The method as claimed in claim 15, wherein the removing is degrading.

17. The method as claimed in claim 15, wherein the removing is rupturing.

18. The method as claimed in claim 15, further including expanding the filtration material.

19. The method as claimed in claim 18, further including applying an actuator fluid to the filtration material to trigger the filtration material to expand.

20. A borehole system comprising:
a borehole in a subsurface formation;
a string in the borehole; and
a tool as claimed in claim 1 disposed as part of or within the string.
